(19) United States
(12) Patent Application Publication
(10) Pub. No.: US 2010/0318412 A1
(43) Pub. Date: Dec. 16, 2010

(54) METHOD AND SYSTEM FOR REAL-TIME LOCATION AND INQUIRY BASED INFORMATION DELIVERY

(75) Inventors: George Karypis, Minneapolis, MN (US); Daniel Bork, East Kingston, NH (US)

Correspondence Address: ANDREWS KURTH LLP, 1350 I STREET, N.W., SUITE 1100, WASHINGTON, DC, 20005, US

(73) Assignee: nXn Tech, LLC, Bloomington, MN (US)

(21) Appl. No.: 12/813,098

(22) Filed: Jun. 10, 2010

Related U.S. Application Data
(60) Provisional application No. 61/185,960, filed on Jun. 10, 2009.

(51) Int. Cl. G06Q 30/00; G01S 19/42; G06F 17/30

(52) U.S. Cl. 705/14.1; 705/14.58; 342/357.25; 707/770; 707/E17.11

(57) ABSTRACT

Systems and methods for real-time location and inquiry based information delivery are described. Embodiments of a method for real-time location and inquiry based information delivery include receiving, using a processor and memory, a customer inquiry. The customer inquiry includes product information indicative of a customer's interest in a particular product. The method further receives location information indicative of the customer's current geographical location, determines additional product information based on the customer inquiry, identifies one or more incentives for presentation to the customer based on at least a portion of the product information and the location information. The customer inquiry is received prior to any solicitation of the customer's interest in the particular product.

### RELATED APPLICATIONS

The present application claims the priority of U.S. Provisional Application Ser. No. 61/185,960, entitled “A Method and System for Providing Real-Time Incentives to Potential Customers for Mobile Marketing,” and filed Jun. 10, 2009, which is hereby incorporated by reference in its entirety.

### BACKGROUND

The delivery of relevant and location-aware, information about products and services to a person while the person is actively making purchasing decisions can increase the person's conversion rates by providing the person with necessary information to influence and complete purchases. As a result, methods and systems that can deliver relevant and location-aware information to a potential customer have important applications in the area of retail industry and commerce in general.

Existing approaches for delivering location-aware information to people do so by following a push model, in which certain content (e.g., reminders, advertisements, incentives) is sent to a person's device based on his current location and, potentially, profile information (e.g., previous purchases, lifestyle factors, etc.).

Though useful, this information may not be relevant for the person's current state-of-mind. For example, if a person is at a particular store and is considering purchasing a particular product, the information that will be most valuable to him at that point is whether or not any other stores (located near-by or online) have the same (or similar) product at a lower price and or whether there are any incentives (e.g., pricing, service, etc) for that product at the current or other stores (located near-by or online). No current systems provide that information. Moreover, it would be valuable to retailers to know that a person is nearby and is interested in products that retailers provide. With such information, the retailers could provide more targeted information. Unfortunately, no current systems provide that information.

### SUMMARY

Embodiments described herein have numerous advantages, including overcoming the defects of the prior art. These advantages may be achieved by a method for real-time location and inquiry based information delivery. The method includes receiving, using a processor and memory, a customer inquiry. The customer inquiry includes product information indicative of a customer's interest in a particular product. The method further receives location information indicative of the customer's current geographical location, determines additional product information based on the customer inquiry, identifies one or more incentives for presentation to the customer based on at least a portion of the product information and the location information. The customer inquiry is received prior to any solicitation of the customer's interest in the particular product. A computer readable medium that includes instructions for performing the above method also achieves these advantages.

These advantages may also be achieved by a system for real-time location and inquiry based information delivery. The system includes a computer including a processor and memory, the memory including a computer program stored therein that includes instructions that are executed by the processor. The instructions may be executed to receive a customer inquiry, the customer inquiry including product information indicative of a customer's interest in a particular product, receive location information indicative of the customer's current geographical location, determine additional product information based on the customer inquiry, and identify one or more incentives for presentation to the customer based on at least a portion of the product information and the location information. The customer inquiry is received prior to any solicitation of the customer's interest in the particular product.

These advantages may also be achieved by a system for real-time location and inquiry based information delivery that includes a reception component, a product information component and a promotion identification component. The reception component receives customer inquiries and customer location information via a network, the customer inquiries including information about particular products in which customers are interested and the location information includes geographical locations of the customers. The product information component, which is in communication with the reception component, retrieves additional product information based on the customer inquiries. The promotion identification component, which is in communication with the product information component, identifies incentives to offer to customers based on at least a portion of the product information and the location information. Customer inquiries are received prior to any solicitations of the customers' interest in particular products.

### BRIEF DESCRIPTION OF THE DRAWINGS

The detailed description may refer to the following drawings, wherein like numerals refer to like elements, and wherein:

FIG. 1 is a block diagram illustrating an embodiment of a system for real-time location and inquiry based information delivery.

FIG. 2 is a flowchart illustrating an embodiment of a method for real-time location and inquiry based information delivery.

FIG. 3 is a flowchart illustrating an embodiment of a method for real-time location and inquiry based information delivery.

FIG. 4 is a block diagram illustrating exemplary hardware components of an embodiment of a.

### DETAILED DESCRIPTION

Described herein are embodiments of a method and system for real-time location and inquiry based information delivery. Embodiments determine that a person is at or near a particular store or stores and is considering purchasing or otherwise interested in a particular product or service (when “product” is used alone, it should be understood that product may mean product, service or a combination of product(s) and service(s)) and provide that person with information as to whether or not any other stores (e.g., located near-by or online) have the same (or similar) product at a lower price and or whether there are any incentives (e.g., pricing, service, etc) for that product at the current or other stores (e.g., located near-by or online). Likewise, embodiments enable retailers, knowing that there is a person interested in a particular product, to, in real-time, create incentives (e.g., a discount coupon) or adjust an existing incentive program in order to entice the customer to purchase the product from them. In embodiments, the real-time incentive creation takes into account a number of different factors that, among others, include whether the person is already at or near the retailer's store or at or near a near-by competitor's store, shipping costs in the case of online retailers, profit margins, and cross-sell/up-sell possibilities.

Note, when stores or retail locations are used herein, it should be understood that these include both physical, “brick-and-mortar” stores and retail locations, but also online stores and retail locations. Moreover, while the embodiments primarily discuss a person, generally referred to as a customer, at a store, it should be understood that in embodiments, a customer may interact with the system and method described here while at other locations, such as near a store, simply walking around, sitting at a café or coffee shop, browsing on-line at home, etc. Beyond providing incentives to potential customers to leave stores at which the customers are currently located, embodiments may provide incentives to steer customers away from nearby stores and to participating retailers, which may also be nearby or even further away.

Embodiments provide real-time incentives to potential customers. An embodiment includes receiving a customer's inquiry about a particular product and a location of the customer. The customer's inquiry is received prior to any solicitation, by embodiments of the system and method described herein, of the customer's interest in the product. Data sources may provide information relevant to the inquiry for presentation to the customer. Participating retailers may provide even more detailed information, including incentives specifically targeted at the customer. For example, participating retailers may maintain business rules governing the offering of incentives. The business rules may be used to determine an appropriate incentive based on the customer's inquiry, the customer's location, and the available pricing information. For example, one participating retailer may offer an incentive to entice the customer away from a present location (e.g., at a competing vendor). Similarly, another participating retailer may offer an incentive to encourage a customer to remain in that vendor's store, rather than leave and make a purchase from an alternate vendor. Finally, incentives are not limited to product discounts, but may include cross-sell and up-sell opportunities.

An exemplary embodiment of a system for real-time location and inquiry based information delivery may include a network for communicating between one or more subsystem components. The subsystem components may include a reception component for receiving an inquiry submission from a customer, a location acquisition component for determining the customer's likely location, a product information component for identifying information relevant to the customer's inquiry, and a promotion identification component for applying business rules to determine one or more appropriate promotions that can be presented to the customer. Embodiments also include a method for real-time location and inquiry based information delivery that determines at least one promotion. The method may include receiving an inquiry from a customer, determining the geographical location and likely store location of the customer, obtaining product information relevant to the inquiry, and identifying at least one promotion for presentation to the customer.

Embodiments include a method for real-time location and inquiry based information delivery that enables a customer to submit an inquiry regarding a specific product or a class of products. This inquiry can be submitted directly by the customer or indirectly via various intermediaries. Embodiments of the method submit the inquiry by using a custom application that runs on the customer's mobile device (e.g., iPhone™ or Android™) or via the use of a web-browser. Examples of intermediaries include phone companies or companies that provide various shopping or comparative pricing services to customers. The inquiry can be submitted in different ways, such as by taking a picture of the product, a scan or picture of the UPC code, by directly typing product identifying information (e.g., name, model, UPC code, etc.), by performing a web-search for certain product types, or by selecting from a list. This information is submitted by the customer by using his/her mobile network capable handheld device (e.g., cell phone, PDA, smart-phone, iPhone™, iPad™, Droid™, netbook, etc.).

Embodiments also include a method for real-time location and inquiry based information delivery that receives an inquiry regarding a specific product or a class of products by a customer. Embodiments may include a computer program that runs on a network connected computer system that receives the inquiry using a web-based protocol. Embodiments may include a database (e.g., relational database) for storing the information for further processing.

Embodiments may also perform methods for determining the location of the customer. The location may be obtained using different approaches. For example, when an inquiry is submitted via a custom application running on the customer's mobile device, the application may be used to determine the location. The application may determine the location by using the application programming interface routines (APIs) provided by the underlying operating system (e.g., iPhone OS, Android, Windows Mobile, WebOS) to determine the location based on the device's built-in GPS antenna, the nearest cell-phone towers, or other network-derived information and sensors. In addition, the customer can directly provide location information to the application. The customer can provide the location information by different means, including zip-code, store name, and street address. When the inquiry is submitted using a web-interface, the location information may be provided directly by the customer. When the inquiry is submitted by an intermediary, the intermediary can provide the location information. The location information is provided to the system at the time that the initial inquiry is submitted.

Embodiments may also perform methods for identifying the most likely physical store(s) at or nearby which the customer is currently located, when this information has not been explicitly provided to the method. Embodiments may determine the physical store based on the customer's determined location by accessing a geographic information system (GIS) database that provides location information of different stores. In the case of low resolution location information, or when there are multiple stores at the same location (e.g., shopping mall), the method selects the most likely physical store by correlating the specific products being queried with the types of products offered at the candidate stores.

Embodiments may also store information about the geographic location of the various stores and types of products being offered at each store. The types of products that each store provides can be obtained either directly from the participating retailers, or by crawling product catalogs in their online stores (when applicable). The information related to the products that each store sells may be stored in a database and be updated periodically to ensure that they reflect the stores/retailers current product inventory.

Embodiments may also find and select information relevant to the product or class of products that were queried by the customer. Embodiments may use the product-related information and the customer's location in searching various data sources to identify relevant information about the specific product or product class. The relevant information may include product pricing, product availability, expert/consumer ratings, product features, competitive products, etc. The search may be focused on physical retailers whose stores are near the customer's current location, and online retailers. Pricing information for online retailers takes into account relevant shipping costs and any associated sales taxes. Examples of data sources that may be searched include product-related information from retailers' product catalogs, information available/provided by price aggregators, product rating sites and services, and information provided directly by participating retailers. Embodiments may perform the search on the fly (i.e., by issuing a multiple queries to the different sources and then aggregating the results), or by first collecting all the relevant information from the different sources in a local data store and then searching the local data store. The collection of information may be done by using a combination of web-crawling, web-services, or data imports from the retailers product catalogs. Embodiments may create a summary of the discovered information and send the summary back to the customer so that he or she can view them on his/hers mobile device. The summary may include competitive pricing information, customer ratings, and similar products. This information may be displayed via the custom application running on the customer's device or as a web-page that the customer can access via his/her browser.

Embodiments may identify, select, and transmit to the customer incentives that are relevant to the product or class of products in which the customer is interested. Embodiments use the product, location, and pricing information in conjunction with various business rules of the participating retailers to identify incentives (e.g., discount coupon, services promotion, etc.) that are delivered directly to the customer's mobile device. The incentives may be delivered to the same mobile application used by the customer to transmit an inquiry (along with the information about the product) or can be delivered in the form of an email, text message, or multi-media message. The incentives may be targeted directly to the specific products that the customer is querying or related product and services.

The business rules may be designed to select the best retailer-specific incentive by taking into account different criteria based on the provided information. When the customer is in the retailer's store, the incentive can be used to either close the sale or for cross-sell or up-sell purposes. For example, if the retailer's pricing information is not competitive in relation to the other retailers that were identified by the system, then an incentive can be selected whose goal is to reduce/eliminate the price disadvantage. If the retailer's pricing is already competitive, then the incentive can be used to steer the customer into a higher-margin replacement product (up-sell) or co-operative products (cross-sell). When the customer is in a competitor's store, the promotion can be used to take away the sale from the competitor by providing additional pricing incentives or just to highlight related products/services.

Embodiments that identify the most appropriate retailer-specific incentives may include a database that stores various incentives/promotions from the participating retailers for different products and/or product classes, and a set of retailer-specific business rules that can be used to either select the appropriate incentive or generate an incentive dynamically based on information that is determined dynamically. This dynamic information may include, for example, the location of the customer relative to the retailer's store (e.g., presence in the retailer's store, presence in a nearby competitor's store), the customer's prior purchasing history (e.g., past response to promotions, loyalty, previous inquiries, etc.), information associated with the specific product (e.g., price competitiveness, availability, profit margins, popularity, cross-sell potential, etc.), information associated with competitor's pricing of the same or similar products in geographically nearby or online stores, and information associated with available budget for promotions. There may be embodiments in which the above information is not stored centrally by the system, but is determined dynamically by directly querying the participating retailer's systems. In these embodiments, the system and method may retrieve the retailer's business rules dynamically during the incentive identification and not maintain any state information.

Given the retailer's business rules and the inquiry-specific information, embodiments may evaluate each of the business rules to determine the ones that apply to an inquiry. In a case where multiple incentives can be offered by the same retailer, then a priority-based scheme, specified by the retailer, may be used to select the appropriate incentive. Embodiments also may perform methods in which none of the retailer's business rules are provided to the system, and the incentive selection system interfaces directly with the participating retailer's systems, provides information about (i) the current product inquiry, (ii) competitive pricing information, and (iii) the customer's current location and gets back in return the incentives that were selected by the retailer's system for communication to the customer (if any). This approach ensures that the retailer's business logic remains opaque to the application.

In the case where multiple promotions/incentives are available from different retailers, embodiments may select a finite subset among the promotions/incentives in order to communicate the promotions to the customer. Different rules may be used to select the communicated incentives including the gain that will be realized by the customer, the price that the retailer is willing to bid/pay in order to have its incentive being selected for communication, or the requirement to ensure that incentives from each participating retailer are communicated at least a certain number or percentage of times.

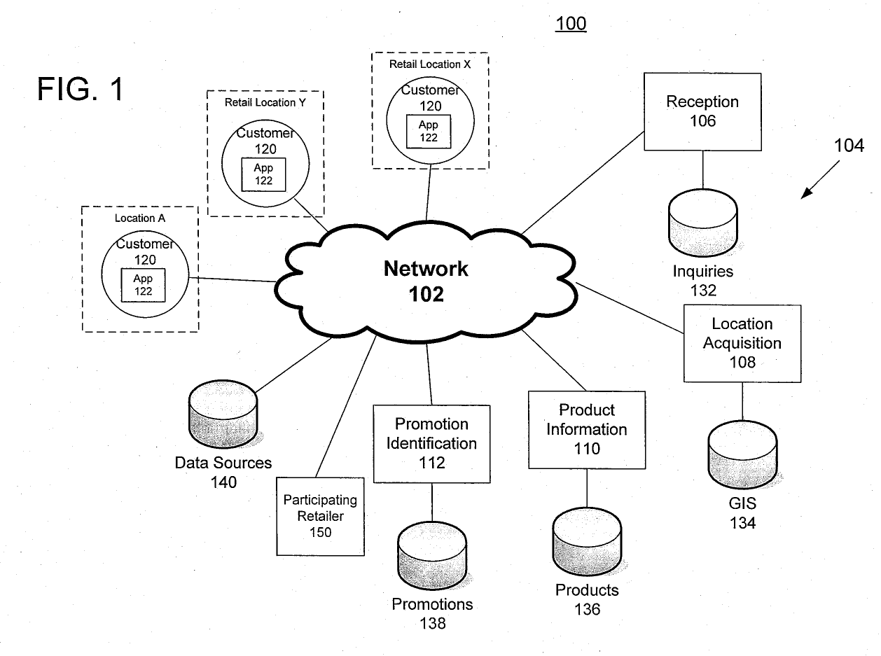

With reference now to FIG. 1, shown is a block diagram illustrating an embodiment of a system 100 for real-time location and inquiry based information delivery. System 100 includes network 102 for communicating with and between one or more sub-system components 104. The subsystem components 104 may include a reception component 106 for receiving an inquiry submission from a customer 120 at a retail location, a location acquisition component 108 for determining the customer's likely location, a product information component 110 for identifying information relevant to the customer's inquiry, and a promotion identification component 112 for applying business rules to determine one or more appropriate promotions, incentives, etc. that can be presented to the customer 120. Subsystem components 104 may be dedicated servers or other dedicated computers that are connected via network 102 or software modules distributed on a plurality of servers or other computers that are connected via network 102 (e.g., internet, dedicated network, LAN, etc.). Alternatively, the subsystem components 104 may be located on a single server or other computer; in such an embodiment, network 102 may simply connect subsystem components 104 to telecommunications network for receiving customer 120 inquiries, transmitting information to customer 120, etc.

System 100 may also include one or more databases, such as the databases described herein. The databases may include an inquiries database 132, e.g., connected locally or via network 102 to reception component 106, in which customer inquiries and relevant information received therewith are stored. The databases may include GIS database 134, e.g., connected locally or via network 102 to location acquisition component 108, with information about the location of stores, retail locations, etc. The databases may also include a product database 136, e.g., connected locally or via network 102 to product information component 110, with information about products and retail locations, and the products sold by the retail locations. Likewise, the databases may include promotions database 138, e.g., connected locally or via network 102 to promotion identification component 112, with information including various incentives/promotions from participating retailers for different products and/or product classes, and a set of retailer-specific business rules that can be used to either select the appropriate incentive or generate an incentive dynamically based on information that is determined dynamically. Alternatively, the databases described herein may be combined as one database that includes some or all of the above information and which may be accessed by the subsystem components 104 via network 102 or local connection.

Customer 120 may include customer mobile device, such as iPhone™, Android™ or other smart-phone. Customer 120 mobile device may include application 122 running on customer mobile device which communicates with system 100 and subsystem components 104 (e.g., via network 102 or otherwise). Application 122, which may be a system 100 component, may automatically communicate relevant information to subsystem components 104, such as inquiry, product information, location information, and other information received by system 100 as described herein. Alternatively, customer 120 may manually enter or select the relevant information in the application 122 and direct the application 122 to transmit the relevant information to the subsystem components 104.

With continuing reference to FIG. 1, when using application 122, customer 120 may be shopping at a retail location (or simply nearby a retail location(s)). Customer 120 may send an inquiry about a given product or service at the retail location to system 100. Customer 120 may generate inquiry by typing in product or service information into customer mobile device (e.g., into application 122), conducting a web-search about a product or service, or as otherwise described above. Alternatively, customer mobile device may be equipped with infra-red, bar-code or other scanning device that enables customer mobile device to scan in product or service information (e.g., from product bar-code or other UPC). Likewise, customer 120 may use customer mobile device to photograph product or service information (e.g., photograph product itself or tag or display with product/service information). Application 122 may process the input product or service information, whether typed, scanned or photographed and send relevant information to subsystem components 104 (e.g., reception component 106) as inquiry. Application 122 may automatically process the input product or service information and automatically generate the inquiry or do so at the request of the customer 120. The relevant information included in the inquiry may include identifying information identifying the product or service (e.g., a UPC code, product-name and/or description, etc.) at the retail location, the price of the product or service at the retail location, and any other material information about the product/service (e.g., product offered as a buy one get one free, product offered in a package deal with another product, warranty offered with product, etc.) at the retail location. If the input product/service information is a photograph, the application 122 may process the photograph on the mobile device to obtain the relevant information, or may simply transmit the photograph to the subsystem components 104 (e.g., product information component 110) to processing. Application 122 may also include information identifying the customer 120 in the inquiry.

When sending the inquiry to subsystem components 104, application 122 may also include location information indicating the geographical location of the customer 120. Application 122 may determine the geographical location based on the device's built-in GPS antenna, triangulation of the nearest cell-phone towers, or other network-derived information and sensors. The customer 120 may manually input the geographical or retail location. Alternatively, location acquisition component 108 may query the customer 120 mobile device or mobile device telecommunication network for geographical location information of customer 120.

With continuing reference to FIG. 1, reception component 106 may receive inquiry from customer 120. Inquiry may include a request for promotions, incentives, etc. related to a product. As noted herein, the inquiry may be purposefully sent by customer 120 or automatically sent by application 122. Inquiry may simply be a request for information about product, which system 100 processes to provide the information and incentives, etc. Reception component 106 may process inquiry to parse out relevant information and otherwise prepare inquiry for further processing by subsystem components 104. For example, reception component 106 may process inquiry to identify the customer 120 and determine whether customer 120 has previously sent inquiries. Reception component 106 may access database, such as database 132, to obtain inquiry and shopping history of customer 120. Reception component 106 may obtain user profile information that customer 120 has stored when registering application 122. Reception component 106 may process inquiry to determine if inquiry included request for information about the product. All of this information may be used by system 100 to prepare a response to an inquiry.

Location acquisition component 108 may receive location information parsed from the inquiry or sent separately, if any. Location acquisition component 108 may determine the physical retail location of the customer 120 (or the nearest physical retail location or locations of the customer 120 if customer 120 is not actually in a physical retail location) using the methods described above. If no location information is received from customer 120, with inquiry or otherwise, location acquisition component 108 may request location information from customer 120 (e.g., by sending message to application 122 on customer 120 mobile device, or telecommunication network of mobile device, requesting location information). Location information provided by customer 120 typically provides geographical location of customer 120 (e.g., of customer 120) mobile device, e.g., map coordinate or latitude-longitude location. Location acquisition component 108 may use this information determine the customer's likely location in relation to surrounding retail locations. System 100 may need more precise information identifying the specific physical retail location of customer 120. Consequently, location acquisition component 108 may access database, such as GIS database 134, to determine customer's likely location in relation to nearby retail locations or specific physical retail location of customer 120. GIS database 134 preferably includes information identifying physical retail locations by geographic location. In the case of low resolution location information, or when there are multiple stores at the same location (e.g., shopping mall), location acquisition component 108 may select the most likely physical retail location by correlating the specific products being queried with the types of products offered at the candidate stores or through other means of determining the most likely physical retail location.

With continuing reference to FIG. 1, product information component 110 may receive and process product information from or with inquiry. Product information component 110 may identify information relevant to the customer's inquiry, including identifying the specific product relevant to or referenced in customer's inquiry, the price of the product, a detailed description of the product, the product class and other relevant information related to the specific product identified in the inquiry. Product information component 110 may identify the relevant product information from various data sources 140 using the methods described above (e.g., on-the-fly searching, etc.). The product information component 110 may receive the product SKU, photo or other identifying information included in the inquiry obtained by and sent from the application 122 and look up the relevant information from product database 136. For example, product information component 110 may receive a SKU of the product from the inquiry and, using the specific physical retail location information determined by location acquisition component 108, look up the price of the product (and other information) identified by the SKU at that retail location in the product database 136. The product information component 110 may also retrieve, e.g., from the product database 136 information indicating which other participating retailers sell the product or service identified in the inquiry. Product information component 110 may forward this information to promotion identification component 112 to use in looking up the applicable business rules.

As noted above, embodiments may create a summary of the discovered information and send the summary back to the customer 120 for viewing on the customer 120 mobile device. The summary may include competitive pricing information, customer ratings, and similar products. This information may be displayed via the application 122 running on the customer's device or as a web-page that the customer 120 can access via a browser. Product information component 110 may transmit responsive product information, e.g., obtained from data sources 140 and/or product database 136, to application 122 on customer 120 mobile device through network 102. This product information may include publicly available promotions, coupons, etc. Alternatively, a subsystem component 104 may transmit product information to mobile network of customer 120 mobile device for communication to application 122.

With this information, and the product information and retail location identified from the inquiry, system 100 may determine specific promotions and or incentives to offer customer 120. Specifically, promotion identification component 112 may determine incentives to offer using the methods described above. For example, promotion identification component 112 may receive the above information obtained from the inquiry and apply business rules (e.g., participating retailer-specific business rules) to this information to determine one or more appropriate promotions, incentives, etc. that can be presented to the customer 120. Promotion identification component 112 may access promotions database 138 to retrieve the applicable business rules. Promotion identification component 112 may filter and only retrieve the business rules that meet certain criteria. The criteria may be programmed into promotion identification component 112 or stored at promotions database 138. For example, promotion identification component 112 may retrieve business rules only for the participating retailers that also sell the product or service identified in the inquiry (e.g., as identified above by product information component 110) and/or only for participating retailers that are within a certain distance of the physical retail location of the customer 120. Other criteria may be used to filter the business rules. Alternatively, business rules themselves may include criteria that determine whether given business rules apply. For example, the business rules for a participating retailers may include a rule that states “only apply if within x distance of identified retail location.”

Promotion identification component 112 may apply the retrieved business rules to the inquiry to determine and select what, if any, incentives, promotions, advertisements, etc. (collectively, “incentives”) to offer to the customer 120. For example, the production identification component 112 may input the specific product information (e.g., information identifying the product, the price of the product, etc) and retail location information into the business rules to produce an output of incentives to offer. Identified incentives may be relevant to the product or class of products in which the customer 120 is interested.

With continuing reference to FIG. 1, virtually any foreseeable type of incentive and situation may be addressed and output by the business rules. For example, the business rules may indicate that an incentive should be offered to the customer 120 if the customer 120 is interested in a certain product and/or if the price of the product is above a certain amount at a retail location (i.e., the location of the customer 120) within a certain distance of the participating retailer (i.e., the participating retailer corresponding to the applied business rules). The business rules may simply indicate that the customer 120 should be informed that a nearby participating retailer(s) has the same product at a lower price. The business rules may include a specific incentive, e.g., a discounted price, additional warranties, service plans, low or no shipping or delivery costs, etc. for the product to offer to the customer 120. The business rules may include rules for dynamically determining, in real-time, an incentive, e.g., calculating a discounted price, below the price of the product at the retail location (e.g., ten (10%) below the product price), calculating a longer warranty term or service plan than the warranty or service plan of the product, bundling additional products or services with the product, calculating reduced shipping costs, etc. Likewise, the business rules may also offer up-selling opportunities by indicating that a higher quality or more premium version of the product or a higher quality or more premium product of the same type or the same product class that may be purchased, e.g., for a discounted price (e.g., for the same price as the product identified in the query) at the participating retailer.

Some business rules may target incentives to customers 120 based on customer-specific data, e.g., obtained from inquiry or determined by reception component 106. For example, customer profile data, customer purchasing history, etc. may be input into business rules for specific, targeted incentives. Indeed, business rules may even reward loyal, repeat customers 120 with additional incentives or provide increased incentives to potential, first-time customers (e.g., because potential customer 120 has history which shows significant spending—a potentially valuable customer).

In embodiments, the business rules or other instructions may prompt promotion identification component 112 to contact participating retailers 150 to request incentives to dynamically provide incentives. Participating retailers 150 may include an automated, participating retailer component that receives inquiry information from promotion identification component 112 (e.g., product identification, price, retail location, etc) and calculates or otherwise provides the incentive. Alternatively, a human operator at participating retailer 150 may receive the communication and relevant inquiry information from promotion identification component 112 and may determine and input the incentive(s) for transmittal back to promotion identification component 112. Promotion identification component 112 may also include a human operator for determining and inputting incentives.

The above-described and other incentives, and manners of calculating incentives, may be output by promotion identification component 112. In sum, promotion identification component 112 may determine and offer to customer 120 virtually any type of incentive to encourage customer 120 to leave retail location at which customer 120 is currently located and go to a participating retailer.

With continuing reference to FIG. 1, in addition to identifying and offering incentives to encourage customer 120 to leave retail location at which customer 120 is located (or, e.g., to move from vicinity of retail location near which customer 120 is located), promotion identification component 112 may also identify incentives to encourage customer 120 to remain at retail location (or to enter retail location near which customer 120 is located). In other words, retail location may also be a participating retailer. If an inquiry is received from a customer 120 at a participating retailer, corresponding business rules for participating retailer may dictate that an incentive, such as a discount coupon for the product identified in the inquiry, be offered to customer 120. Incentives may include comparison information comparing price, service offered and other advantages of participating retailer versus retail location at or near which customer 120 is located (promotion identification component 112 may generate such comparison information based on participating retailed business rules and information about the retail location gathered by product information component 110). Other incentives, as described above, such as cross-selling or up-selling opportunities, package deals (e.g., a discounted price for a combination of products), service plan deals, warranty deals, etc. may also be identified. Incentives may also include e-coupons or links to online retailers or participating retailer websites enabling customer 120 to select and execute a purchase offered through the e-coupon or link on the website.

Promotion identification component 112 may also identify incentives for more than one participating retailer. Likewise, promotion identification component 112 may identify multiple incentives from the same participating retailer. Consequently, customer 120 may be presented with multiple incentives from one or more participating retailers. Business rules for participating retailer may condition offering of incentives on the offering of incentives from other participating retailers. For example, if promotion identification component 112 identifies incentives from a participating retailer other than the participating retailer at which customer 120 is located, the business rules may identify incentives to offer from participating retailer where customer 120 is located (“counter-incentives”). Indeed, participating retailers may have business rules dictating multiple rounds of counter-incentives be offered to customers 120. Such counter-incentives may be dynamically calculated based on the last incentive sent by a competing participating retailer. In embodiments, system 100 may enable human operators (e.g., at participating retailers) to view the incentives offered by other participating retailers. Consequently, the human operators may determine and offer counter-incentives.

Moreover, embodiments may also enable participating retailers to bid on the offering of their incentives, where the highest bid dictates that that participating retailer's incentive is exclusively offered. Such bidding may occur prior to the customer 120 shopping, or dynamically, in real-time while customer 120 is shopping and incentives are being identified. Embodiments may also enable exclusive incentive contracts in which only one participating retailer's incentives are offered in certain situations or markets or for certain products. Consequently, promotion identification component 112 may select a subset of identified incentives for presentation to the customer 120. Promotion identification component 112 may select the subset (one or more) of incentives by filtering out incentives based on exclusivity contracts, customer-profile settings (e.g., no incentives for retailers more than x distance away, no incentives from y retailers, etc.), bidding results, repetitive incentives, requirements to ensure that incentives from each participating retailer are communicated at least a certain number or percentage of times, etc.

With continuing reference now to FIG. 1, promotion identification component 112, or other subsystem component 104 (e.g., reception component 106), may communicate the identified incentive(s) to the customer 120. The identified and selected incentives may be delivered to the same mobile application used by the customer to transmit an inquiry (along with the information about the product) or can be delivered in the form of an email, text message, or multi-media message. For example, promotion identification component 112 may transmit identified incentive(s) to application 122 on customer 120 mobile device through network 102. Alternatively, a subsystem component 104 may transmit incentive(s) to mobile network of customer 120 mobile device for communication to application 122.

Customer 120 may generate and send additional inquiries while continuing to shop. Application 122 may monitor customer 120 location and transmit additional inquiries to system 100 if customer 120 leaves current retail location or if customer 120 enters a new retail location, thereby triggering additional incentive identification and offering. Further, if incentives included e-coupons or links to participating retailer websites as described, customer 120 may execute purchase online from transmitted incentive. System 100 may record the customer purchase in database 132.

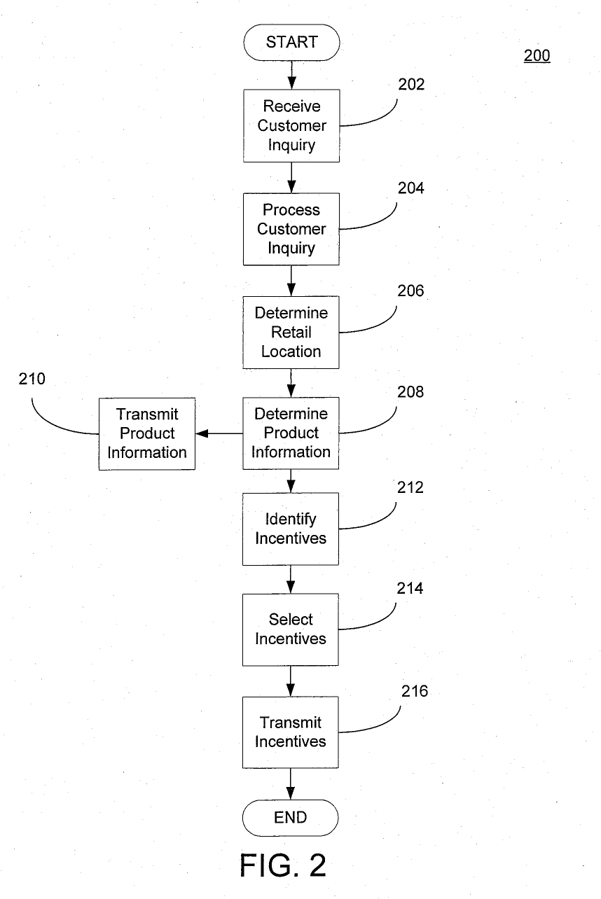

With reference now to FIG. 2, shown is an embodiment a method 200 for real-time location and inquiry based information delivery. Method 200 may be performed by embodiments of system 100 described above or other systems, such as computer systems executing instructions to perform the steps described herein. Method 200 may perform the following steps as described above with reference to system 100 or otherwise. Method 200 receives a customer's inquiry about a product and a location of the customer from a customer at or near a retail location, block 202. As noted, customer location may be geographical location of customer determined, e.g., by application on customer mobile device. Customer location may be separate or part of inquiry. Customer inquiry may be received from a customer mobile device, e.g., from an application of embodiments described herein, running on customer mobile device. Upon receiving 202 inquiry, method 200 may process inquiry, block 204, parsing out product information (e.g., information about product about which customer is inquiring), location information, and whether customer is asking for additional product information. The location information is processed and specific, physical retail location (or locations) is determined, block 206, e.g., as described above. Product information is determined, block 208, e.g., as described above. For example, method 200 may access various outside data sources or system databases to determine more specific product information, as described. In certain instances, a customer inquiry may not be about or include information about a specific product. For example, customer may be in or near a fast-food restaurant and may simply submit an inquiry with his/her location (e.g., application 122 may send inquiry based on customer's location, which system 100 may process to determine customer is located at a specific retail location). Method 200 may process the location, determine specific retail location and determine 208 products sold at the retail location, in this example, fast food.

If requested, method 200 may transmit product information to customer, block 210. Method 200 may use this determined product information, customer-specific information (user profile, prior inquiries and purchases, etc), and other information from inquiry, for identifying incentives, block 212, as described above. The incentives may be identified 212 based on participating retailer-specific business rules, as described above. Alternatively, human operators may provide the identified incentives, as described above. Participating retailers may provide various incentives, including incentives specifically targeted at the customer, as described above. Method 200 may separately select a subset of the identified incentives, block 214, based on various criteria (e.g., exclusively contracts, bid prices, customer profile options (e.g., only within x miles), best match of incentives to product, etc.). Method 200 transmits identified and selected incentives to customer, block 214. Continuing the example, method 200 may identify 212 incentives offered by participating fast-food retailers and provide those to customer at fast-food restaurant, even if a specific fast-food product is not identified in the inquiry.

With continuing reference to FIG. 2, method 200 may repeat for additional inquiries. Moreover, based on, e.g., business rules and/or incentives sent, method 200 may repeat certain steps. For example, business rules may dictate identifying 212 additional and/or counter-incentives, as described above. The additional or counter-incentives may be transmitted 214 as above. Method 200 may repeat these steps as needed.

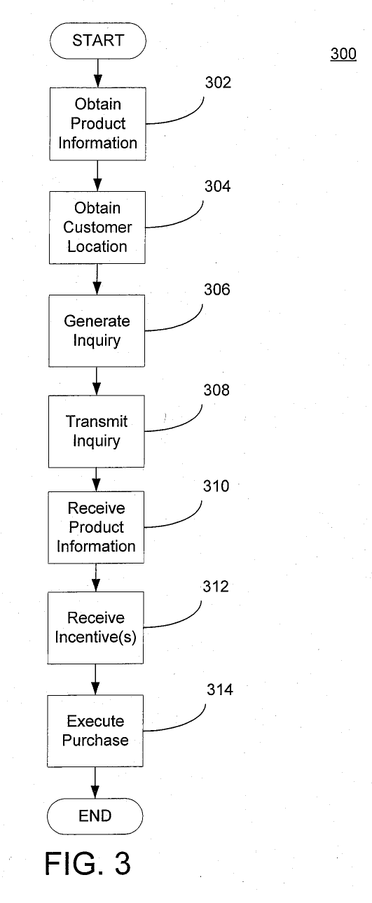

With reference now to FIG. 3, shown is a customer-side embodiment of a method 300 for real-time location and inquiry based information delivery. Method 300 may be performed by application 122 (e.g., on customer 120 mobile device or other computing device). Method 300 may obtain product information, block 302. The product information may be obtained 302 as described above. For example, application 122 may receive information typed in or otherwise entered by customer, scanned into mobile device, or from a product web-search conducted by customer. Method 300 may obtain the customer location, block 304. The customer location may be obtained 304 as described above. For example, application 122 may obtain customer mobile device location from GPS antenna, communications network (e.g., through triangulation) or from information entered by customer. Method 300 generates inquiry, block 306. The inquiry may be generated 306 as described above. For example, application 122 may automatically generate the inquiry or customer may manually select or enter inquiry, e.g., using application 122. Method 300 transmits inquiry, block 308. The inquiry may be transmitted 308 to system 100, e.g., to reception component 106 via network 102. Method 300 may receive requested product information, block 310. After receiving 310 product information, method 300 may transmit 308 additional inquiries based on the received information. Method 300 may receive incentives, e.g., transmitted from system, block 312. Upon receiving incentives, method 300 may execute purchase of product referenced in incentive, block 314. The purchase may be executed online, e.g., through web-browser on customer 120 mobile device, or in person at retail location. As noted above, customer 120 may continue to shop and send 308 additional inquiries. Likewise, customer 120 may send 308 additional inquiries prior to actually purchasing product. If customer 120 changes location, method 300 may re-obtain 304 customer location and generate 306 an additional inquiry, as noted above.

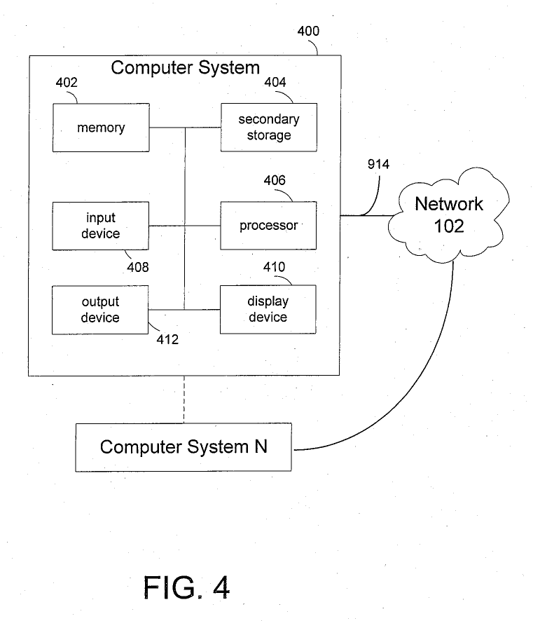

With reference now to FIG. 4, shown is a block diagram illustrating exemplary hardware components for implementing embodiments of system 100 and method 200 for real-time location and inquiry based information delivery. Server 400, or other computer system similarly configured, may include and execute one or more subsystem components 104 to perform functions described herein, including steps of method 200 described above. Likewise, a mobile device which includes some of the same components of computer system 400 may run application 122 and perform steps of method 300 described above. Computer system 400 may connect with network 102, e.g., Internet, or other network, to receive inquires, obtain data, and transmit information and incentives as described above.

Computer system 400 typically includes a memory 402, a secondary storage device 404, and a processor 406. Server 400 may also include a plurality of processors 406 and be configured as a plurality of, e.g., bladed servers, or other known server configurations. Server 400 may also include an input device 408, a display device 410, and an output device 412. Memory 402 may include RAM or similar types of memory, and it may store one or more applications for execution by processor 406. Secondary storage device 404 may include a hard disk drive, floppy disk drive, CD-ROM drive, or other types of non-volatile data storage. Processor 406 executes the application(s), such as subsystem components 104, which are stored in memory 402 or secondary storage 404, or received from the Internet or other network 102. The processing by processor 406 may be implemented in software, such as software modules, for execution by computers or other machines. These applications preferably include instructions executable to perform the system and subsystem component (or application 122) functions and methods described above and illustrated in the FIGS. herein. The applications preferably provide graphical user interfaces (GUIs) through which users may view and interact with subsystem components 104 (or application 122 in mobile device).

Computer system 400 may store one or more database structures in secondary storage 404, for example, for storing and maintaining databases 132-138, and other information necessary to perform the above-described methods. Alternatively, such databases 132-138 may be in storage devices separate from subsystem components 104.

Also, as noted, processor 406 may execute one or more software applications in order to provide the functions described in this specification, specifically to execute and perform the steps and functions in the methods described above. Such methods and the processing may be implemented in software, such as software modules, for execution by computers or other machines. The GUIs may be formatted, for example, as web pages in HyperText Markup Language (HTML), Extensible Markup Language (XML) or in any other suitable form for presentation on a display device depending upon applications used by users to interact with the system 100 (or application 122).

Input device 408 may include any device for entering information into computer system 400, such as a touch-screen, keyboard, mouse, cursor-control device, touch-screen, microphone, digital camera, video recorder or camcorder. The input device 408 may be used to enter information into GUIs during performance of the methods described above. Display device 410 may include any type of device for presenting visual information such as, for example, a computer monitor or flat-screen display (or mobile device screen). The display device 410 may display the GUIs and/or output from sub-system components 104 (or application 122). Output device 412 may include any type of device for presenting a hard copy of information, such as a printer, and other types of output devices include speakers or any device for providing information in audio form.

Examples of computer system 400 include dedicated server computers, such as bladed servers, personal computers, laptop computers, notebook computers, palm top computers, network computers, mobile devices, or any processor-controlled device capable of executing a web browser or other type of application for interacting with the system.

Although only one computer system 410 is shown in detail, system 100 may use multiple computer system or servers as necessary or desired to support the users and may also use back-up or redundant servers to prevent network downtime in the event of a failure of a particular server. In addition, although computer system 400 is depicted with various components, one skilled in the art will appreciate that the server can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling a computer system, computer system 400, to perform a particular method, such as methods described above.

The terms and descriptions used herein are set forth by way of illustration only and are not meant as limitations. For example, while the embodiments are described as providing incentives based on real-time location and inquiries received from a mobile device, other types of information may be provided based on such information. Those skilled in the art will recognize that many variations are possible within the spirit and scope of the invention as defined in the following claims, and their equivalents, in which all terms are to be understood in their broadest possible sense unless otherwise indicated.

1. A method for real-time location and inquiry based information delivery, comprising:
receiving, using a processor and memory, a customer inquiry, wherein the customer inquiry includes product information indicative of a customer's interest in a particular product;
receiving location information indicative of the customer's current geographical location; and
identifying one or more incentives for presentation to the customer based on at least a portion of the product information and the location information;
wherein the customer inquiry is received prior to any solicitation of the customer's interest in the particular product.

2. The method of claim 1 further comprising transmitting the identified one or more incentives to the customer.

3. The method of claim 1 further comprising determining a specific retail location of the customer from the geographical location of the customer;

4. The method of claim 3 wherein the incentives include discount offers for retailers located within a certain distance of the specific retail location of the customer.

5. The method of claim 3 wherein the incentives encourage the customer to leave the specific retail location.

6. The method of claim 3 wherein the geographical location of the customer is determined from a GPS location of a customer mobile device.

7. The method of claim 3 wherein the identifying comprises inputting the specific retail location and the product information into one or more business rules.

8. The method of claim 1 further comprising determining additional product information based on the customer inquiry.

9. The method of claim 8 further comprising transmitting the additional product information for presentation to the customer.

10. The method of claim 1 further comprising selecting an incentive from the identified one or more incentives.

11. The method of claim 1 wherein the identifying utilizes one or more business rules to identify the one or more incentives.

12. The method of claim 11 wherein the one or more business rules include one or more retailer-specific business rules.

13. The method of claim 1 further comprising identifying counter-incentives for participating retailers.

14. The method of claim 1 wherein the identifying comprises dynamically calculating one or more incentives.

15. The method of claim 1 wherein the incentives include one or more of the following: discounts, service plans, warranties, package deals or up-sell opportunities.

16. The method of claim 1 further comprising determining a plurality of retail location near which the customer is located.

17. The method of claim 1 wherein the identifying comprises transmitting a portion of the product information and the location information for presentation to a human operator.

18. The method of claim 1 wherein identifying comprises receiving one or more incentives selected by a human operator.

19. The method of claim 1 in which the customer's current geographical location is at a retail location.

20. The method of claim 1 wherein the incentives include discount offers for retailers located within a certain distance of the geographic location of the customer.

21. A computer readable medium comprising instructions for performing the method of claim 1.

22. A system for real-time location and inquiry based information delivery, comprising:
a computer including a processor and memory, wherein the memory includes a computer program stored therein that includes instructions that are executed by the processor for:
receiving a customer inquiry, wherein the customer inquiry includes product information indicative of a customer's interest in a particular product;
receiving location information indicative of the customer's current geographical location;
determining additional product information based on the customer inquiry; and
identifying one or more incentives for presentation to the customer based on at least a portion of the product information and the location information;
wherein the customer inquiry is received prior to any solicitation of the customer's interest in the particular product.

23. A system for real-time location and inquiry based information delivery, comprising:
a reception component that receives customer inquiries and customer location information via a network, wherein the customer inquiries include information about particular products in which customers are interested and the location information includes geographical locations of the customers;
a product information component, in communication with the reception component, that retrieves additional product information based on the customer inquiries; and
a promotion identification component, in communication with the product information component, that identifies incentives to offer to customers based on at least a portion of the product information and the location information;
wherein customer inquiries are received prior to any solicitations of the customers' interest in particular products.

24. The system of claim 23 further comprising a plurality of databases.

25. The system of claim 24 wherein the databases include:
an inquiries database, connected to reception component, in which customer inquiries and relevant information received therewith are stored;
a products database, connected to product information component, with information about products and retail locations, and the products sold by the retail locations; and
a promotions database, connected to promotion identification component, with information including various incentives from participating retailers for different products and product classes, and a set of retailer-specific business rules that can be used to either select the appropriate incentive or generate an incentive dynamically.

26. The system of claim 22 further comprising a location acquisition component, in communication with the reception component, which determines specific retail locations of the customers from the geographical locations of the customers.

27. The system of claim 26 further comprising a GIS database, connected to location acquisition component, with information about the location of stores, retail locations.

28. The system of claim 23 wherein the reception component includes a processor and a memory.

29. The system of claim 28 wherein the memory includes instructions that are executed by the processor to receive customer inquiries and customer location information.
